(19) United States
(12) Patent Application Publication
(10) Pub. No.: US 2007/0050729 A1
(43) Pub. Date: Mar. 1, 2007

(54) Display apparatus, method, and program

(75) Inventors: Takuya Kawamura, Kawasaki-Shi (JP); Hiroshi Kawazoe, Yokohama-Shi (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 11/512,421

(22) Filed: Aug. 30, 2006

(30) Foreign Application Priority Data
Aug. 31, 2005 (JP) 2005-252042

(51) Int. Cl. G06F 17/00; G06F 3/00

(52) U.S. Cl. 715/781; 715/517; 715/788

(57) ABSTRACT

There is provided with a display apparatus including: a display apparatus which displays a first window and a second window, comprising: a receiver configured to receive a composite object obtained by composing a first object and a second object, from a server; a display unit configured to display the composite object in the first window; a window overlap detector configured to detect an overlap between the second window and the composite object in the first window, and to obtain a position of the overlap in the first window; a layout determiner configured to determine layouts of the objects in the composite object according to the position of the overlap so as not to place the first object and the second object on the position of the overlap; and a transmitter configured to transmit information of the layouts of the objects determined by the layout determiner, to the server.

### CROSS-REFERENCE TO RELATED APPLICATIONS

This application is based upon and claims the benefit of priority from the prior Japanese Patent Applications No. 2005-252042 filed on Aug. 31, 2005, the entire contents of which are incorporated herein by reference.

### BACKGROUND OF THE INVENTION

1. Field of the Invention

The present invention relates to a display apparatus, a display method, and a program, which display, for example, a composite video image in a multipoint video conference system utilizing an image composition server.

2. Related Art

As the graphical user interface develops, it is possible in personal computers (PCs) of today to display a plurality of windows on a display (called desktop as well). The display windows are managed by a window display system. The user conducts work while freely operating the windows on the desktop. Among a plurality of display windows, a window which accepts user's operation is called active window. Furthermore, there is a concept of overlapping in windows. For example, there is a front-rear relation between two windows. A rear window is partially or wholly hidden by a front window in some cases. Since in general a desktop area is restricted, the number of windows which can be disposed so as not to overlap each other in the area is limited. In order to effectively use the restricted desktop area, therefore, the user conducts work by actively utilizing overlapping of windows and using a desired window as an active window while operating the front-rear relation between windows as occasion demands.

Although it is possible to effectively use the desktop area by utilizing window overlapping, the overlapping causes trouble that contents displayed by the rear window are hidden and unseen. For ascertaining contents displayed by the rear window, it is necessary for the user to move the rear window to the front or another place having no overlapping. In order to reduce the labor of this manual operation, therefore, a method of automatically changing the display position of the rear window in a window display system is conceivable. Or a method of automatically making the front window transparent in the window display system is also conceivable. As for the operation in the window display system, it is also conceivable that the rear or front window itself detects overlapping and conducts display position movement processing and processing of making the display transparent on the own window.

On the other hand, as a method for automatically displaying data which has disappeared from display due to overlapping of windows without using the technique such as moving or making transparent, a method of moving the start position of data displayed in a window is proposed in JP-A 1997-81107 (KOKAI). In JP-A 2004-234426 (KOKAI), it is mentioned as a problem that an interface object (an operation button such as a minimization button, a maximization button, or a scroll bar) attached to a window is hidden by overlapping of windows, and a method of moving the interface object to a position having no overlapping in the window and displaying the interface object is proposed.

It is possible to construct a multipoint video conference system by exchanging video images and voices between information devices capable of transmitting and receiving data via a network.

When constructing a multipoint video conference system including a plurality of conference terminals, there are a method of mutually exchanging video images between conference terminals, and a method of utilizing a conference server, transmitting video images from conference terminals to a conference server, composing (mixing) video images received from a plurality of conference terminals to form one video image in the conference server, and then delivering the resultant video image to the terminals. Especially in the latter method, it suffices to receive a video image from the single conference server, and consequently the network load can be reduced as compared with the former method. The conference using the former method and the conference using the latter method are sometimes called distributive multipoint conference and concentrated multipoint conference, respectively.

The conference server is sometimes called MCU (Multipoint Control Unit) as well.

Video images received from respective terminals are respectively referred to as video sources. As for positions in which respective video sources are arranged in a composite video image, there are a method in which the conference server automatically determines the positions and a method in which respective terminals exercise control over the positions. For example, in the case where the number of video sources is four, there are various composition patterns as to the arrangement position of the video sources, such as the case where the composite image is arranged so as to be divided into four parts, and the case where with respect to one video image the remaining three video images are arranged like pictures in picture. In the case where control is exercised from each terminal, there is a method in which one is selected from among predetermined patterns and a notice thereof is sent to the conference server to change a composite video image. Besides the method of changing the video arrangement by ordering a pattern, a method of specifying arrangement positions of video sources from the terminal side is also conceivable.

If, in a multipoint video conference system in which one composite video image is transmitted from a conference server to terminals by utilizing a conference server, a terminal which displays the received composite video image is a PC, the composite video image is displayed in one window.

A method of automatically changing the display position of a rear window when the window display system has detected overlapping of windows is conceivable. If the position of the rear window is moved, however, then there is a possibility that a problem that a third window is hidden or the rear window is hidden by a third window will occur. Even if a contrivance such as downscaling of the window at the time of movement is conducted, this problem cannot be completely avoided. Furthermore, a method of making the front window transparent in the window display system is also conceivable. If the front window is made transparent or semitransparent, however, it becomes possible for the user to ascertain the display contents of the rear window. However, hardness to see caused by the fact that overlapping contents of the two windows are displayed poses a problem.

On the other hand, even if a technique of moving the start position of data displayed in a window or changing the display position of the window is used when overlapping is detected by the function of the window display system or an application for operating individual windows, there is a possibility that data which should be originally displayed will not be displayed resulting in a problem. In other words, if the start position of data displayed in the window is moved, there is a possibility that a video image of a portion which has protruded from the window will not be displayed. Furthermore, if there is not a sufficient area in a movement destination when the display position of the window is changed, there is a possibility that a part of a video image in the window will be still hidden by another window. For example, the following problems occur.

It is supposed that in a state in which faces of a plurality of participants are displayed in one window in the video conference system a window of a different application for presentation materials is displayed. In this case, a face of a participant becomes unseen due to overlapping of windows.

In the same way as the video conference system, a surveillance camera system is supposed. If in a state in which video images of a plurality of points are displayed in one window another work window is started, an important video image becomes unseen in some cases.

### SUMMARY OF THE INVENTION

According to an aspect of the present invention, there is provided with a display apparatus comprising: a display apparatus which displays a first window and a second window, comprising: a receiver configured to receive a composite object obtained by composing a first object and a second object, from a server; a display unit configured to display the composite object in the first window; a window overlap detector configured to detect an overlap between the second window and the composite object in the first window, and to obtain a position of the overlap in the first window; a layout determiner configured to determine layouts of the objects in the composite object according to the position of the overlap so as not to place the first object and the second object on the position of the overlap; and a transmitter configured to transmit information of the layouts of the objects determined by the layout determiner, to the server.

According to an aspect of the present invention, there is provided with a display apparatus which displays a first window and a second window, comprising: an object receiver configured to receive a first object and a second object; a layout storage configured to store layouts of the first object and the second object; a composite object generator configured to compose the first and second objects according to the layouts of the first and second objects to generate a composite object; a display unit configured to display the composite object in the first window; a window overlap detector configured to detect overlap between the second window and the composite object in the first window, and to obtain a position of the overlap in the first window; a layout determiner configured to determine layouts of the first and second objects according to the position of the overlap so as not to place the first object and the second object on the position of the overlap; and a layout updater configured to update the layouts of the first and second objects in the layout storage by using the determined layouts of the first and second objects.

According to an aspect of the present invention, there is provided with a program which is executed by a computer, comprising instructions for: receiving a composite object obtained by composing a first object and a second object, from a server; displaying the composite object in a first window; detecting overlap between a second window and the composite object in the first window; obtaining a position of the overlap in the first window; determining layouts of the objects in the composite object according to the position of the overlap so as not to place the first object and the second object on the position of the overlap; and transmitting information of the determined layouts to the server.

According to an aspect of the present invention, there is provided with a program which is executed by computer, comprising instructions for: receiving a first object and a second object; composing the first and second objects according to layouts of the first and second objects to generate a composite object; displaying the composite object in a first window; detecting overlap between a second window and the composite object in the first window; obtaining a position of the overlap in the first window; determining layouts of the objects on the basis of the detected position so as not to place the first object and the second object on the position of the overlap; and updating the layouts of the first and second objects by using the determined layouts of the first and second objects.

### BRIEF DESCRIPTION OF THE DRAWINGS

FIG. 1 is a schematic diagram showing a multipoint video conference system;

FIG. 2 is a diagram showing an exterior view of a conference terminal or a display apparatus;

FIG. 3 is a block diagram showing configurations of a conference terminal and a conference server according to a first embodiment;

FIGS. 4A and 4B are diagrams showing coordinate axes of a display area in a window according to the first embodiment;

FIG. 5 is a diagram showing a first screen image example according to the first embodiment;

FIG. 6 is a diagram showing a first layout information example according to the first embodiment;

FIG. 7 is a diagram showing a first layout control signal example according to the first embodiment;

FIGS. 8A and 8B are diagrams showing a second screen image example according to the first embodiment;

FIG. 9 is a diagram showing a second layout information example according to the first embodiment;

FIG. 10 is a diagram showing a second layout control signal example according to the first embodiment;

FIGS. 11A and 11B are diagrams showing a third screen image example according to the first embodiment;

FIG. 12 is a diagram showing a third layout information example according to the first embodiment;

FIG. 13 is a diagram showing a third layout control signal example according to the first embodiment;

FIGS. 14A and 14B are diagrams showing a fourth screen image example according to the first embodiment;

FIG. 15 is a diagram showing a fourth layout information example according to the first embodiment;

FIG. 16 is a diagram showing a fourth layout control signal example according to the first embodiment;

FIG. 17 is a diagram showing coordinate axes of a composite video image in a conference server according to the first embodiment;

FIG. 18 is a diagram showing a layout management table according to the first embodiment;

FIG. 19 is a diagram showing an example of processing of generating a composite video image from four video sources according to the first embodiment;

FIGS. 20A to 20E are first diagrams showing an example of video data obtained after scaling according to the first embodiment;

FIGS. 21A to 21E are second diagrams showing an example of video data obtained after scaling according to the first embodiment;

FIG. 22 is a block diagram showing a configuration of a display apparatus according to a second embodiment;

FIG. 23 is a diagram showing how display apparatuses are connected by a network according to the second embodiment;

FIG. 24 is a diagram showing an example of operation of a display apparatus according to the second embodiment;

FIGS. 25A and 25B are first diagrams showing how windows overlap according to a third embodiment;

FIG. 26 is a second diagram showing how windows overlap according to the third embodiment;

FIG. 27 is a third diagram showing how windows overlap according to the third embodiment;

FIG. 28 is a fourth diagram showing how windows overlap according to the third embodiment;

FIG. 29 is a diagram showing an example of a composite video image generated from four video sources according to the third embodiment;

FIGS. 30A and 30B are first diagrams showing how a layout of a composite video image is automatically changed according to the third embodiment;

FIGS. 31A and 31B are second diagrams showing how a layout of a composite video image is automatically changed according to the third embodiment;

FIGS. 32A and 32B are third diagrams showing how a layout of a composite video image is automatically changed according to the third embodiment;

FIG. 33 is a diagram showing an additional configuration according to a fourth embodiment; and

FIGS. 34A and 34B are diagrams showing how a layout is changed by user's operation according to the fourth embodiment.

### DETAILED DESCRIPTION OF THE INVENTION

### First Embodiment

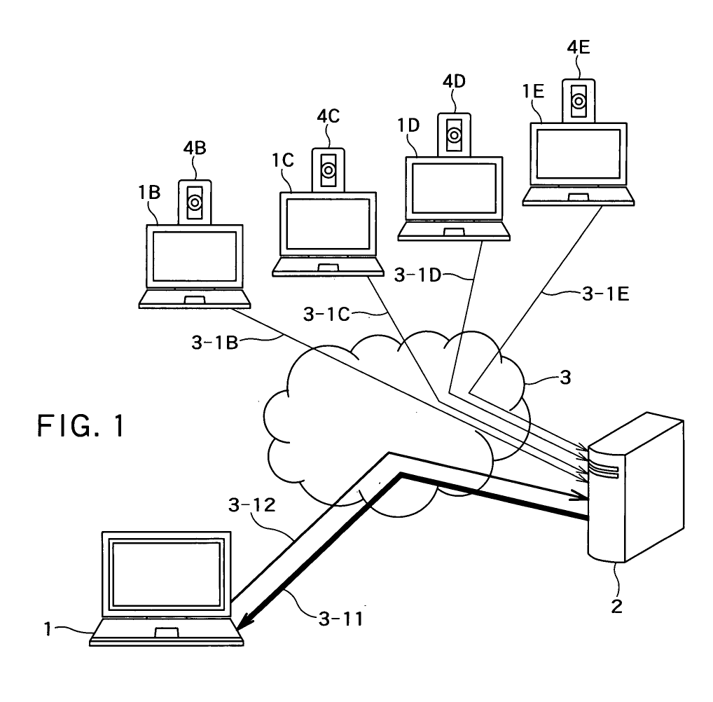

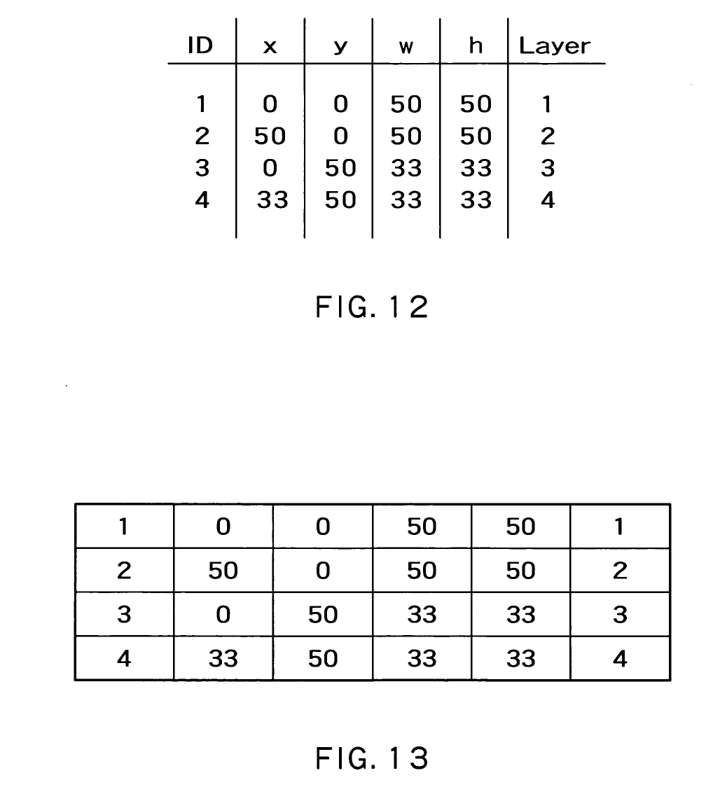

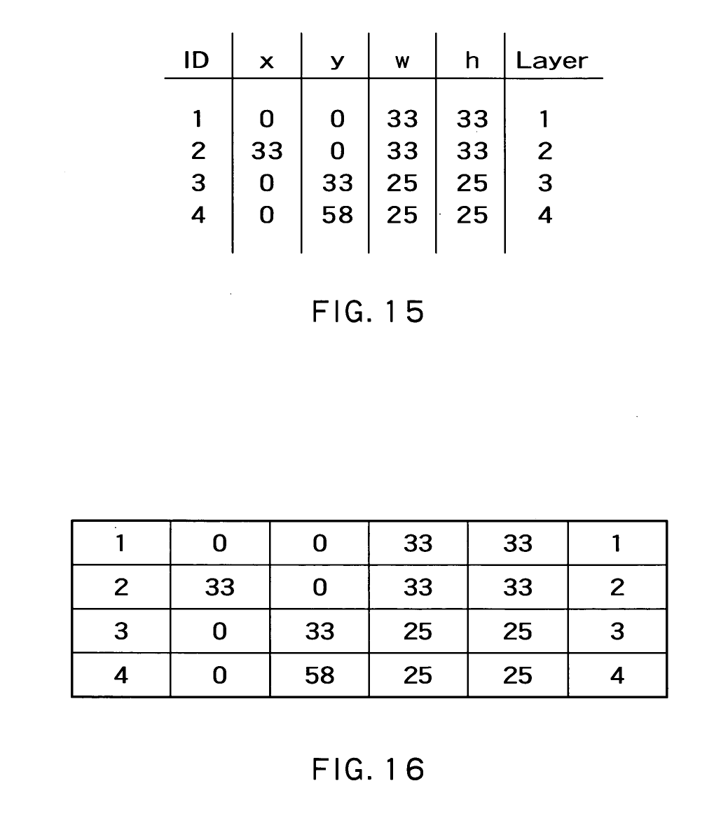

Hereafter, a first embodiment of the present invention will be described with reference to FIGS. 1 to 21.

FIG. 1 shows a system configuration of a multipoint video conference system according to the present invention. FIG. 1 shows an example of the case where video conference is conducted at five points. The system shown in FIG. 1 includes conference terminals 1, 1B, 1C, 1D and 1E and a conference server 2. The conference terminals 1, 1B, 1C, 1D and 1E are connected to the conference server 2 via a network 3.

In the present embodiment, the conference terminals 1B, 1C, 1D and 1E have a function of transmitting video data to the conference server 2 by utilizing communication paths 3-1B, 3-1C, 3-1D and 3-1E, respectively. The conference server 2 has a function of composing video images received from the conference terminals 1B, 1C, 1D and 1E into one video image in a state in which the conference server 2 is connected simultaneously to the conference terminals 1, 1B, 1C, 1D and 1E, and transmitting a resultant composite video image to the conference terminal 1. The video data transmitted by the conference terminals 1B, 1C, 1D and 1E may be video data generated utilizing respective camera devices 4B, 4C, 4D and 4E, or video data stored in respective conference terminals. On the other hand, the conference terminal 1 has a function of receiving video data transmitted by the conference server 2 by utilizing a communication path 3-11 between it and the conference server 2 and transmitting a control signal to the conference server 2 by utilizing a communication path 3-12. By the way, the conference terminal 1 may have a function of transmitting video data to the conference server 2 in the same way as the conference terminals 1B, 1C, 1D and 1E. The conference terminals 1B, 1C, 1D and 1E may have a function of receiving video data from the conference server 2 in the same way as the conference terminal 1. Since only video data is described in the present embodiment, description concerning transmission and reception of voice data which are originally an indispensable function of the multipoint video conference system will be omitted.

The conference terminals 1, 1B, 1C, 1D and 1E are, for example, personal computers (hereafter referred to as PCs) or PDAs (Personal Digital Assistants) having a function of conducting communication via the network. The conference terminals 1, 1B, 1C, 1D and 1E have a function of displaying video data received from the conference server 2. The present embodiment will now be described supposing that the conference terminal 1 is a PC of notebook type having the Windows™ OS of the Microsoft Corporation mounted thereon.

In the present embodiment, it is supposed that the conference server 2 has a function of generating a composite video image from four video data received from the conference terminals.

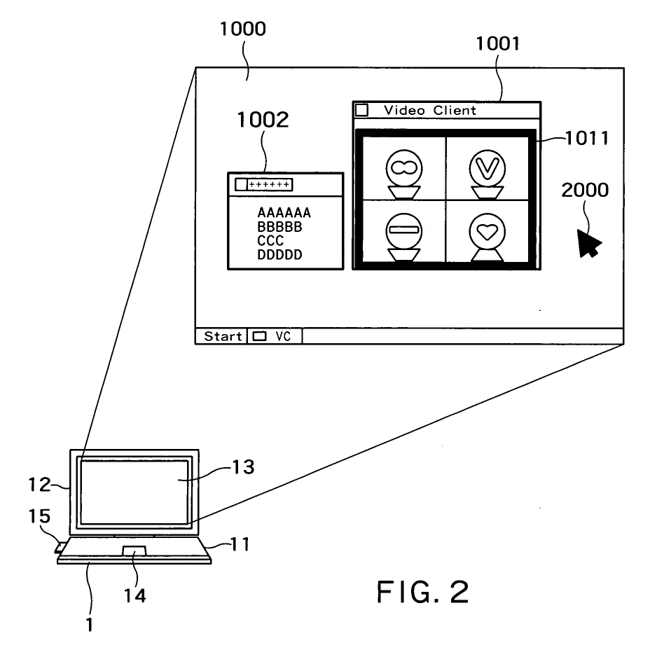

FIG. 2 is an exterior oblique view with a display unit of the conference terminal 1 opened. The conference terminal 1 includes a computer main body 11 and a display unit 12. An LCD (Liquid Crystal Display) 13 forming a display panel is incorporated into the display unit 12. The LCD 13 is located substantially in the center of the display unit 12.

A desktop screen 1000 is displayed on a screen display of the display unit 12 (on a screen of the LCD 13). Windows 1001 and 1002 and a pointer 2000 are displayed on the desktop screen (hereafter referred to simply as screen) 1000. By the way, since the display function of the windows 1001 and 1002 themselves and the display function and operation function of the pointer 2000 are already mounted on ordinary PCs, description of them will be omitted here.

The computer main body 11 has a thin box-shaped cabinet. On a top surface of the computer main body 11, a pointing device 14 is disposed to conduct operation concerning the pointer 2000. In addition, a network communication device 15 is incorporated in the computer main body 11. By the way, the pointing device 14 is disposed on the computer main body 11. For example, in a PC utilizing an external mouse, however, the mouse corresponds to the pointing device 14. The network communication device 15 is a device which executes network communication. The network communication device 15 includes, for example, a physical connector for connection to the network. The network communication device 15 executes data transfer according to a command input from a CPU in the computer main body 11. Its control is conducted according to a communication protocol stored in a memory in the computer main body 11.

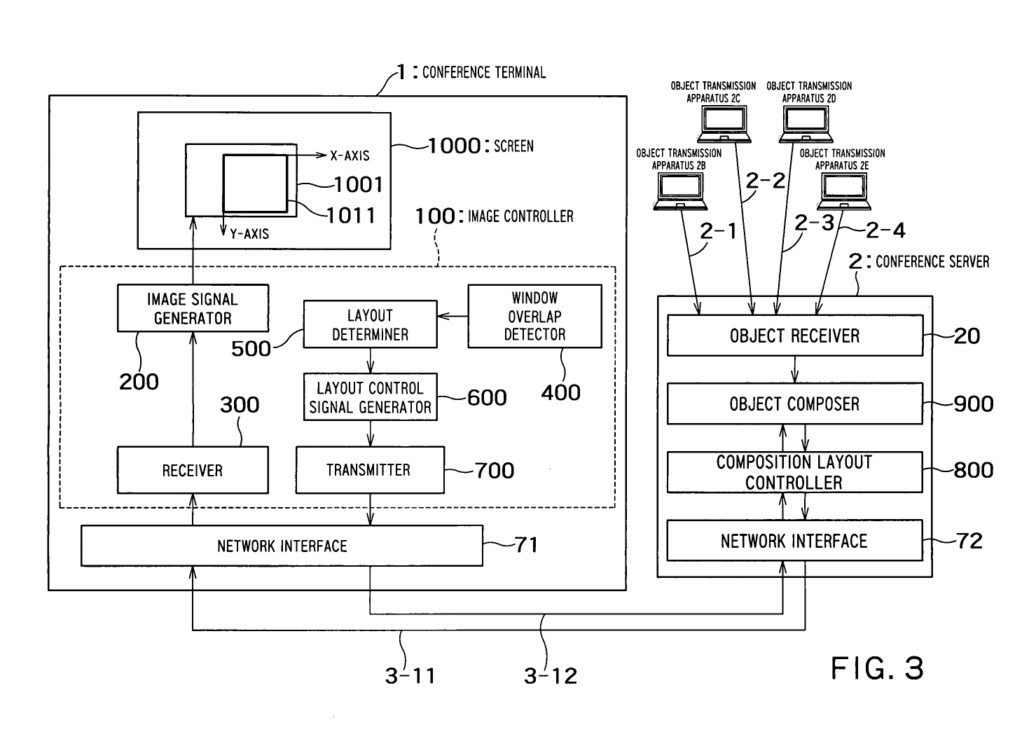

FIG. 3 shows internal components in the conference terminal 1 shown in FIG. 1 or 2. Although FIG. 3 shows how the conference terminal 1 is connected to the conference server 2 via a network, expression of components (such as the CPU) that do not exert direct influence in implementing function improvements according to the present embodiment is omitted. Functions represented by the configuration shown in FIG. 3 may be implemented by causing the computer to execute a program generated using an ordinary programming technique or implemented in a hardware manner.

The conference terminal 1 includes an image controller 100, which forms a feature of the present embodiment, as its components. The conference terminal 1 is supposed to be a PC. The image controller 100 can display drawing data generated by itself on the screen 1000 shown in FIG. 2 as well, by utilizing a drawing function mounted on the PC. Furthermore, the image controller 100 can receive video data via the communication path 3-11 shown in FIG. 1 by utilizing a function of a network interface 71, and transmit control data via the communication path 3-12. The network interface 71 can conduct real time transfer or data transfer corresponding to streaming by utilizing the communication path 3-11. The network interface 71 supports, for example, UDP/IP, RTP or the like as a communication protocol.

The image controller 100 includes an image signal generator 200, a receiver 300, a window overlap detector 400, a layout determiner 500, a layout control signal generator 600 and a transmitter 700.

The receiver 300 acquires video data delivered from the conference server 2 via the communication path 3-11 shown in FIG. 3, through the network interface 71, and outputs the video data to the image signal generator 200. The image signal generator 200 has a function of generating and displaying the window 1001. The image signal generator 200 constructs video data which can be displayed, from video data input from the receiver 300, and displays the video data, for example, in a display area 1011 in the window 1001 as shown in FIG. 2 as “a video image.”

The window overlap detector 400 can detect a display position, a size and a transparency, of a different window. By utilizing the function, the window overlap detector 400 can detect whether a different opaque window overlaps the display area 1011 in the window 1001 and detect its overlapping quantity.

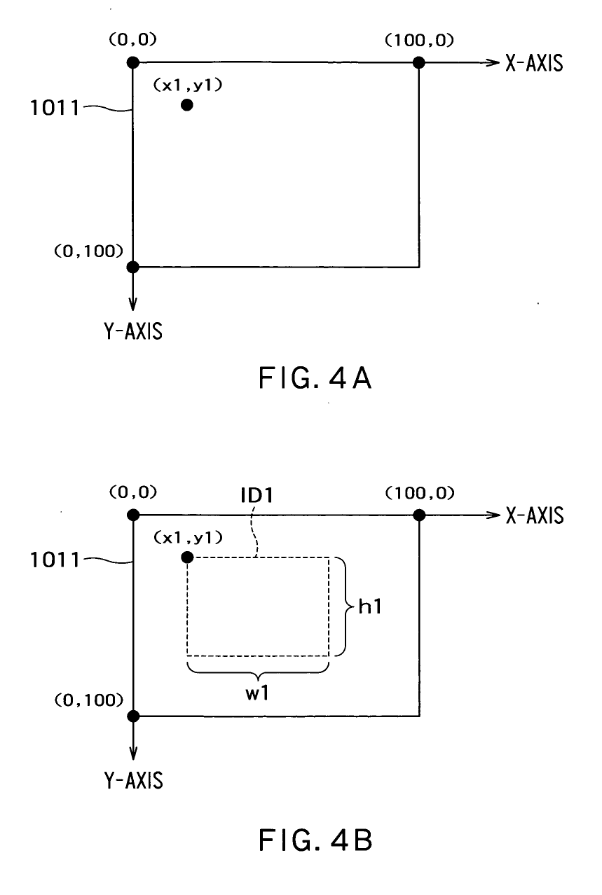

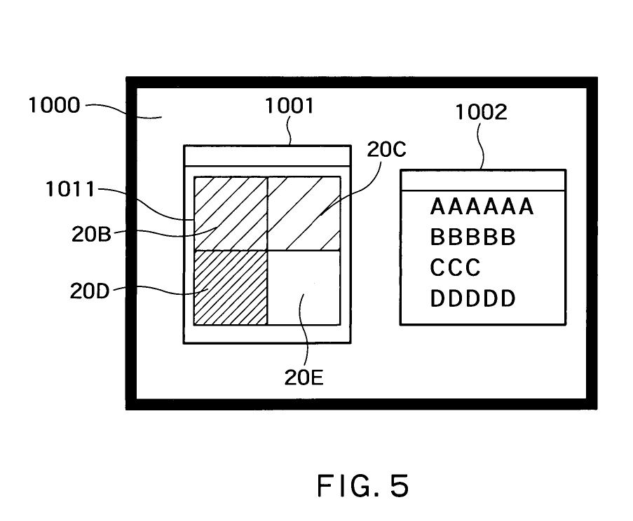

The layout determiner 500 manages layout information of the composite video image displayed by the image signal generator 200. The layout determiner 500 manages the display area 1011 in the window 1001. Using X-Y coordinates, the layout determiner 500 manages, for example, an upper left-hand vertex of the display area 1011 as (0, 0), an upper right-hand vertex as (100, 0), a lower left-hand vertex as (0, 100), and a lower right-hand vertex as (100, 100) as shown in FIG. 4A. It is supposed that in a default state respective pictures (20B, 20C, 20D and 20E) in a composite video image are arranged so as to divide the display area 1011 in the window 1001 into four parts as shown in FIG. 5. The layout determiner 500 manages layouts of respective pictures in this state as layout information shown in FIG. 6. Each of rows in FIG. 6 corresponds to a layout of one object (here, one picture). The one layout includes at least a dimension (size) and position of the object. In some cases, the layout includes an ID and a layer as in the present example. In FIG. 6, an ID of each layout identifies a picture (20B, 20C, 20D or 20E). ID=1 represents 20B. ID=2 represents 20C. ID=3 represents 20D. ID=4 represents 20E. Furthermore, x and y, and h and w represent the position and size of each picture, respectively. For example, a rectangle shown in FIG. 4B is represented as x=x1, y=y1, h=h1 and w=w1. The layer is used to represent a layer position of each picture. For example, if a picture is located on a kth layer, it follows that layer=k. By the way, a rectangular area on the kth layer assumes a higher rank than a rectangular area on a (k+1)th layer. At the time of initialization or the like, the layout determiner 500 outputs default layout information (FIG. 6) to the layout control signal generator 600. When exercising layer control, it is necessary to use the parameter “layer.” In the present embodiment, however, this value is not utilized actively.

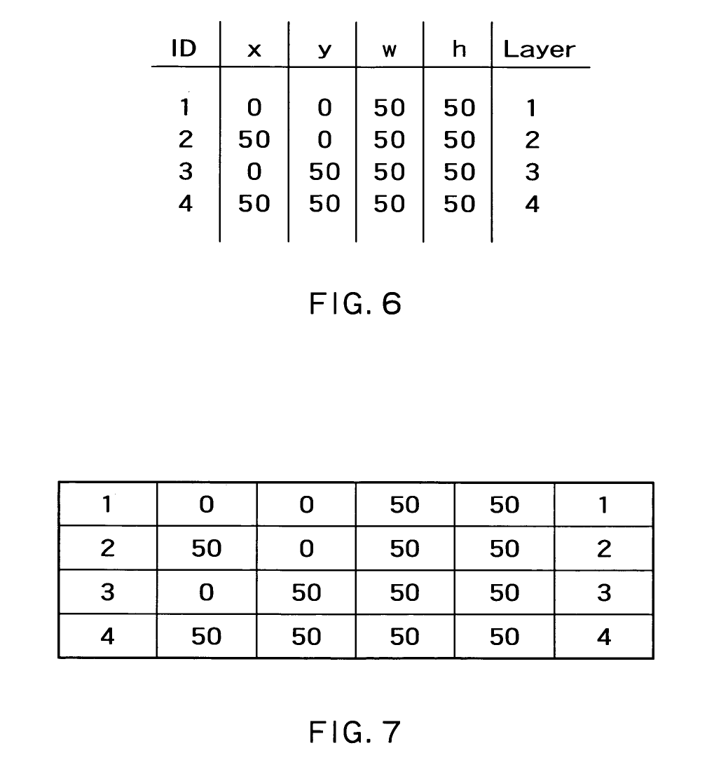

Upon being supplied with layout information from the layout determiner 500, the layout control signal generator 600 constructs a layout control signal to convey the layout information to the conference server 2. FIG. 7 shows an example of the layout control signal for the layout information shown in FIG. 6. In FIG. 7, each block has eight bits and a bit string of each block is represented by a decimal number. Upon generating the layout control signal, the layout control signal generator 600 outputs it to the transmitter 700.

Upon being supplied with the layout control signal from the layout control signal generator 600, the transmitter 700 uses the layout control signal as a payload part in a layout control packet to be transmitted to the conference server 2. The transmitter 700 outputs the layout control packet to the network interface 71 together with additional information such as destination address information of the network required to transmit the layout control packet to the conference server 2. Upon being supplied with the layout control packet having the additional information added thereto from the transmitter 700, the network interface 71 transmits the layout control packet to the conference server 2 via the communication path 3-12.

In FIG. 3, internal components in the conference server 2 are shown. The conference server 2 corresponds to a server. In FIG. 3, expression of components (such as a CPU) which do not exert direct influence in implementing the function improvement according to the present embodiment is omitted.

The conference server 2 includes an object receiver 20, an object composer 900, a composition layout controller 800 and a network interface 72. Utilizing a function of the network interface 72, the composition layout controller 800 can transmit video data via the communication path 3-11 shown in FIG. 1 and receive control data via the communication path 3-12 shown in FIG. 3. The network interface 72 can conduct real time transfer or data transfer corresponding to streaming via the communication path 3-11. The network interface 72 supports, for example, UDP/IP, RTP or the like as a communication protocol.

The object receiver 20 receives objects delivered from four object transmission apparatuses 2B, 2C, 2D and 2E shown in FIG. 3 respectively via communication paths 2-1, 2-2, 2-3 and 2-4, and outputs the objects to the object composer 900. The object transmission apparatuses 2B, 2C, 2D and 2E shown in FIG. 3 correspond to the conference terminals 1B, 1C, 1D and 1E shown in FIG. 1, respectively. The communication paths 2-1, 2-2, 2-3 and 2-4 shown in FIG. 3 correspond to the communication paths 3-1B, 3-1C, 3-1D and 3-1E shown in FIG. 1, respectively. Objects delivered from respective apparatuses correspond to video data. Four video data are referred to as 20B, 20C, 20D and 20E.

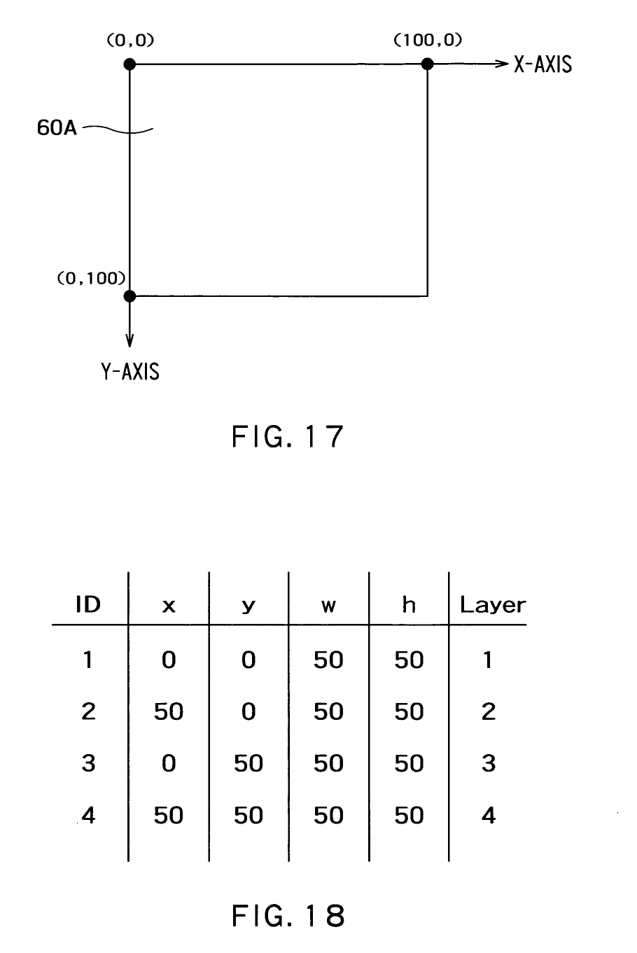

Upon being supplied with video data from the object receiver 20, the object composer 900 composes them and generates a composite video image 60A. This composite video image corresponds to the composite object. That is, the object composer 900 composes the objects input from the object receiver 20 and generates a composite object. In generating a composite video image 60A, the object composer 900 has a function of being able to adjust the image size, arrangement position and layer position of each video data in the composite video image 60A. The object composer 900 manages the composite video image 60A by using X-Y coordinates with each of the horizontal direction and the vertical direction normalized to a value of 100 as shown in FIG. 17, and manages the image size, arrangement position and layer position of each video data by using a layout management table as shown in FIG. 18. ID numbers in the layout management table identify four video data 20B, 20C, 20D and 20E. An arrangement position (x, y), a size (w, h) and a layer of each video data are described in the layout management table. The object composer 900 determines arrangement positions of respective video data in the composite video image 60A by using the layout management table, and generates the composite video image 60A. At that time, however, it is possible to upscale, downscale or cut video images as occasion demands, or conduct surrounding complementing or layer control. The object composer 900 outputs the composite video image 60A to the composition layout controller 800. In the present embodiment, the object composer 900 periodically confirms contents of the layout management table, generates the composite video image 60A according to the contents of the layout management table, and outputs the composite video image 60A to the composition layout controller 800.

On the other hand, the composition layout controller 800 acquires a layout control packet delivered from the conference terminal 1 via the communication path 3-12 shown in FIG. 3, through the network interface 72. After analyzing the layout control signal, the object composer 900 updates the contents of the layout management table in use on the basis of an analysis result. Upon being supplied with the composite video image 60A from the object composer 900, the composition layout controller 800 delivers the composite video image to the conference terminal 1 via the communication path 3-11 by utilizing the network interface 72.

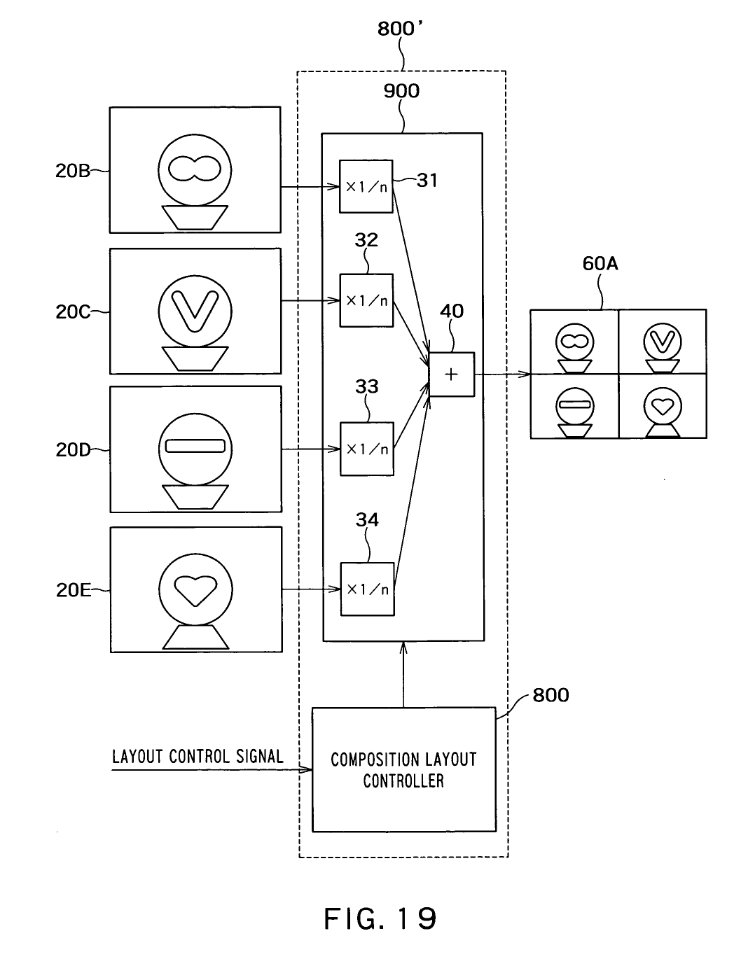

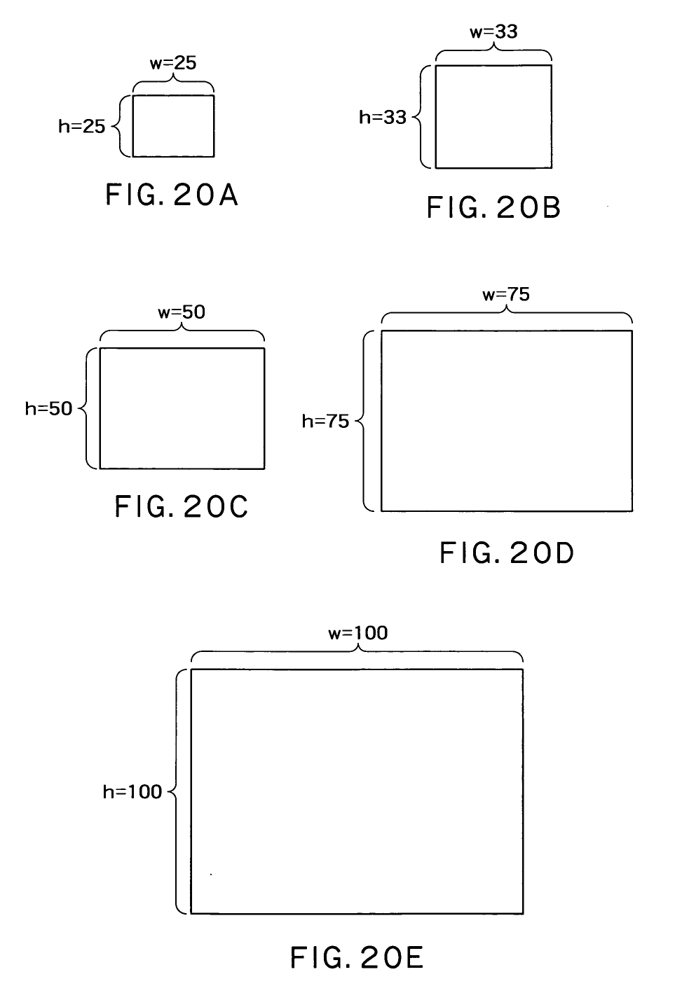

FIG. 19 shows how the composite video image 60A is generated from the video data 20B, 20C, 20D and 20E for the layout management table shown in FIG. 18, as an example of processing conducted in the object composer 900. Here, it is supposed that the video data 20B, the video data 20C, the video data 20D and the video data 20E correspond to the ID number 1, ID number 2, ID number 3 and ID number 4, respectively. In FIG. 19, the object composer 900 includes scaling circuits 31, 32, 33 and 34 and a composition circuit 40 which composes scaled video images. For example, video data are scaled to various sizes as shown in FIGS. 20A to 20E, and then composed.

It is now supposed that a different opaque window 1002 shown in FIG. 5 is moved onto a display area 1011 in a window 1001 in which a composite video image is displayed, by user's operation.

Upon detecting the overlapping caused by the different window, the window overlap detector 400 outputs the overlapping quantity to the layout determiner 500. The overlapping quantity is represented as an overlapping position by using X-Y coordinates (for example, such as “overlapping position: X>50” or “overlapping position: X>50 and Y>50”).

Upon being supplied with the overlapping quantity, the layout determiner 500 calculates an area having no overlapping caused by the different window on the display area 1011 represented by X-Y coordinates, and conducts processing so as to arrange respective pictures (20B, 20C, 20D and 20E) included in the composite video image in areas having no overlapping. As a result of this processing, the layout determiner 500 updates layout information, and outputs the updated layout information to the layout control signal generator 600.

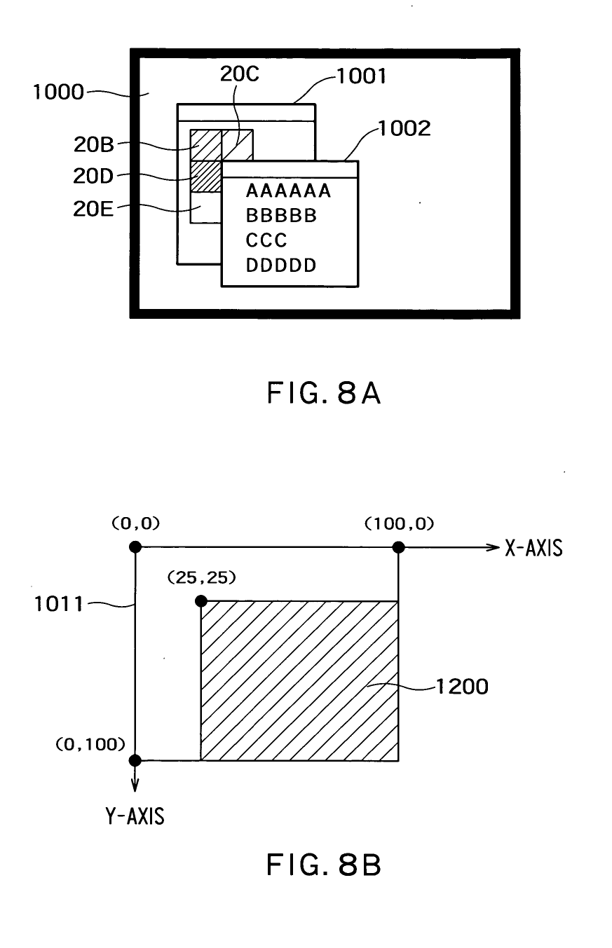

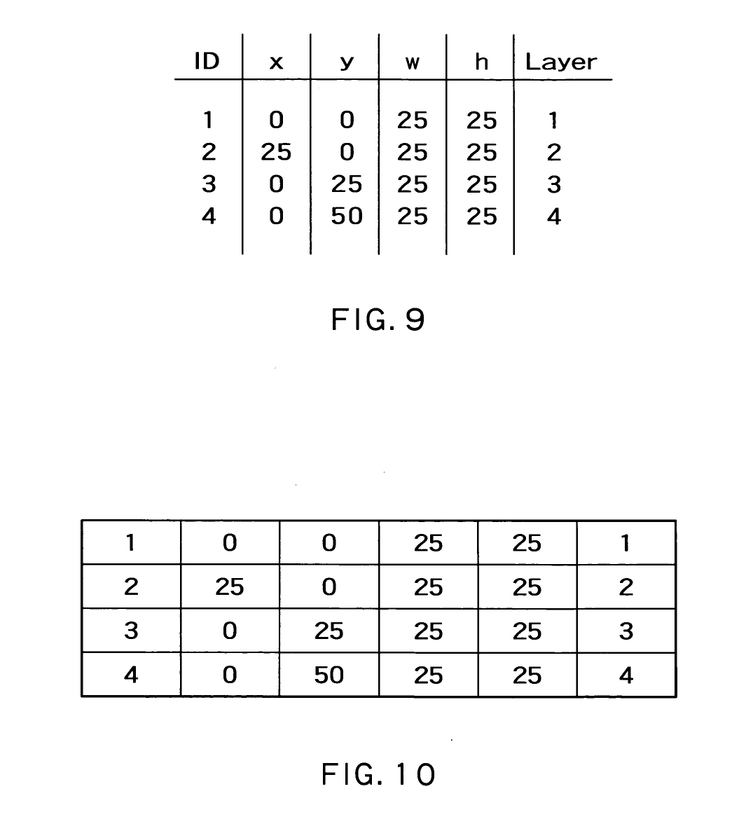

It is now supposed that a different window 1002 is moved onto a display area 1011 in a window 1001 in which a composite video image is displayed as shown in FIG. 8A, by user's operation and the window overlap detector 400 detects overlapping caused by the different window. The window overlap detector 400 calculates an overlapping quantity 1200 shown in FIG. 8B. In the case of FIG. 8B, the overlapping position becomes “X>25 and Y>25.” The layout determiner 500 changes the layout information, for example, as shown in FIG. 9 so as to avoid the area. The updated layout information is output to the layout control signal generator 600. A layout control signal shown in FIG. 10 is generated, and finally conveyed to the composition layout controller 800 in the conference server 2 via the communication path 3-12. If the layout control signal shown in FIG. 10 is recognized in the conference server 2, the arrangement of the composite video image is changed by processing conducted in the composition layout controller 800 and the object composer 900 and the composite video image is transmitted to the conference terminal 1 via the communication path 3-11. FIG. 8A shows how the layout of the composite video image displayed in the window 1001 is changed as a result of the above-described processing after overlapping of the different window 1002 is detected.

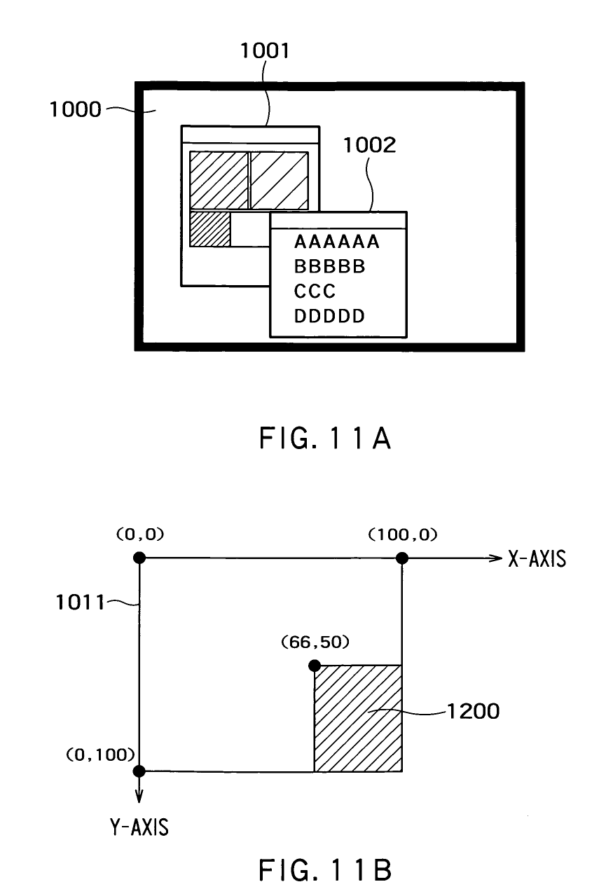

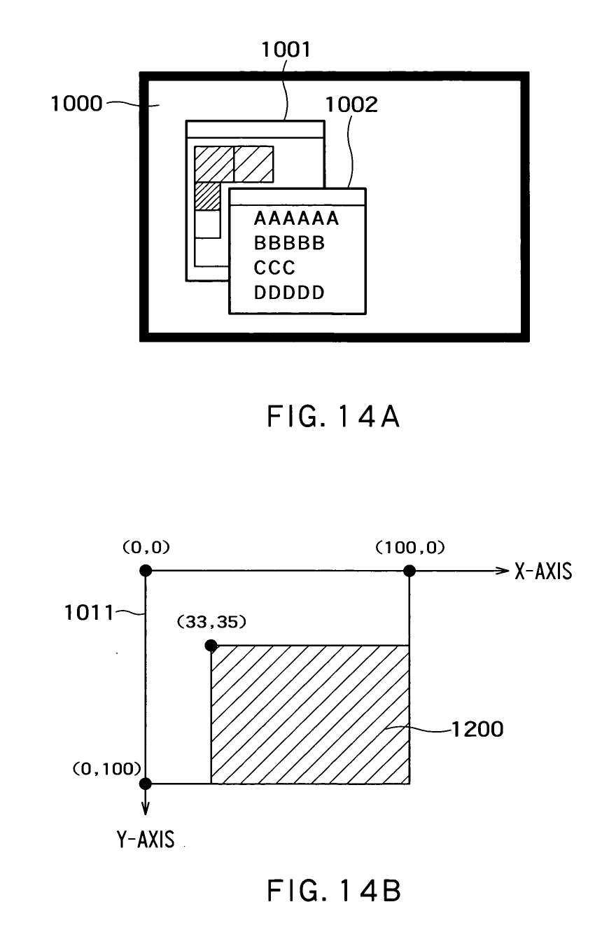

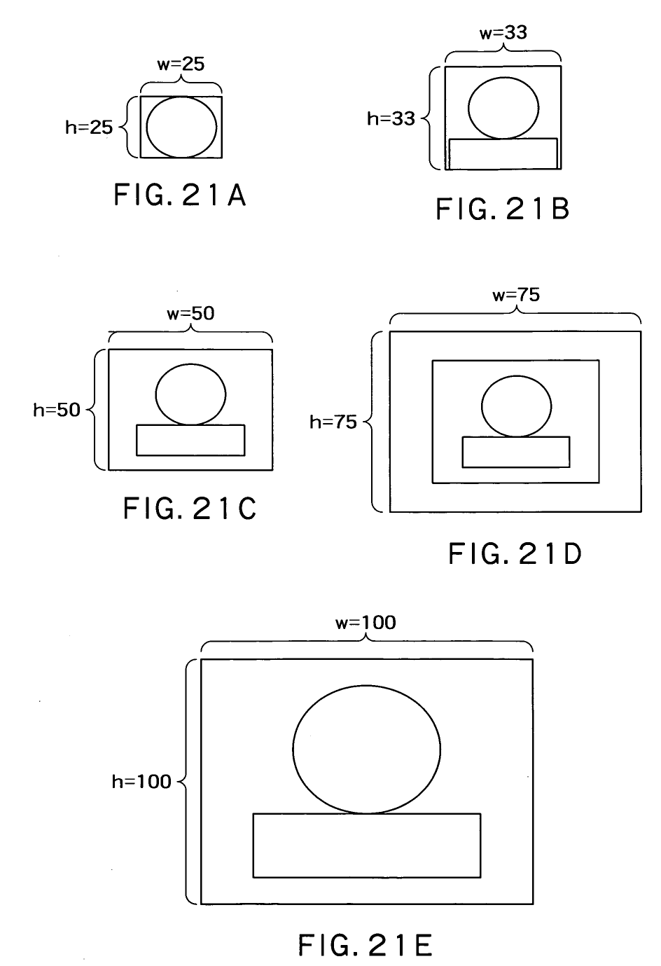

In the same way, FIGS. 11A, 11B, 12 and 13 show an example of how the layout is changed when the overlapping position has become “X>66 and Y>50.” FIGS. 14A, 14B, 15 and 16 show an example of how the layout is changed when the overlapping position has become “X>33 and Y>35.” When the layout information is generated, the size of each video data is set from among five patterns respectively shown in FIGS. 20A to 20E. As for the size of respective video data, analysis and composition processing are conducted by the composition layout controller 800 and the object composer 900 in the conference server 2. However, it is not always possible to change the respective video data to sizes specified in the conference server 2. For example, in FIGS. 21A to 21E, it is supposed that the object composer 900 can downscale video data from the original size (FIG. 21E) only to half size (FIG. 21C) when the object composer 900 downscales video data while keeping the image aspect ratio constant. If in that case a quarter size (FIG. 21A) or a one-third size (FIG. 21B) is specified, then video data obtained by deleting the surroundings from the half size is used. On the other hand, if a size of three-fourths (FIG. 21D) is specified, then the surroundings of the half size may be complemented.

In the present embodiment, the number of video images to be composed is set equal to four in order to simplify the description. Alternatively, the number of video images to be composed may be set equal to eight or sixteen etc. by expanding the present embodiment.

Heretofore, the detailed configuration and operation of the conference terminal 1 and the conference server 2 have been described as the first embodiment of the present invention. When a different front window overlaps a window which displays a composite object, it becomes possible according to the present embodiment to dynamically rearrange the composite object to display the composite object in an area which causes no overlapping, while following the movement of the front window.

For example, in a state in which faces of a plurality of participants are displayed in one window in the video conference system, a window of a different application for presentation materials is displayed. In this case, a phenomenon that a face of a participant is made unseen by overlapping of windows occurs. When a different front window overlaps a window which is displaying a face of a participant, however, the composite layout is changed following the movement of the front window and the face of the participant is displayed in an area having no overlapping according to the present embodiment.

### Second Embodiment

Hereafter, a second embodiment of the present invention will be described with reference to FIGS. 22 to 24, FIG. 2, FIGS. 5 to 7, and FIGS. 17 to 19.

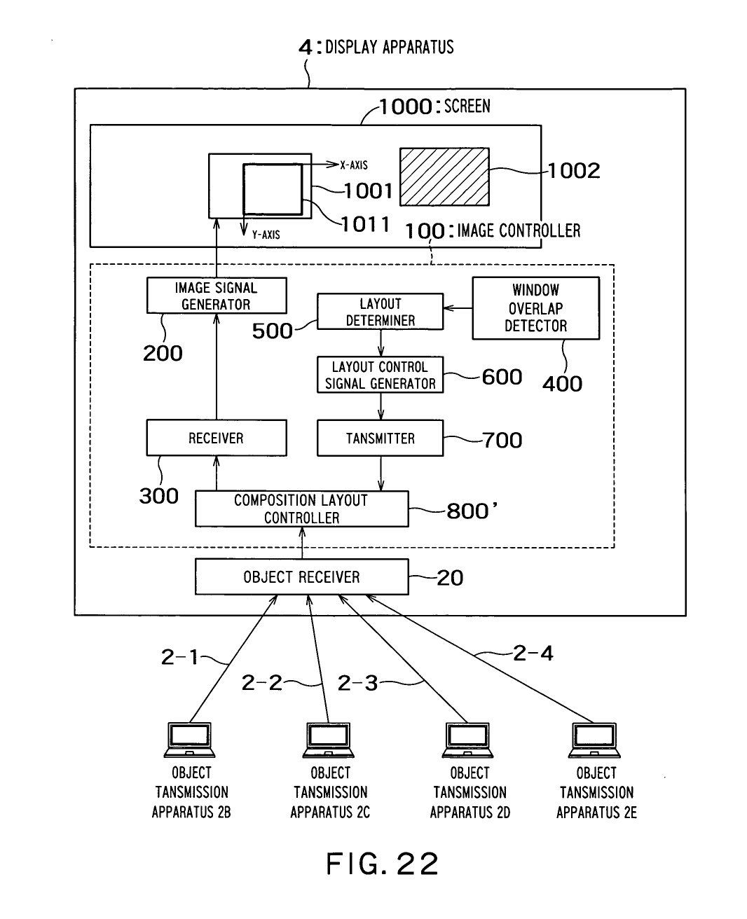

FIG. 22 shows an internal configuration of a display apparatus 4 according to the present embodiment. The display apparatus 4 is, for example, a personal computer (hereafter referred to as PC) or PDA (Personal Digital Assistant) having a function of conducting communication via a network. The present embodiment will now be described supposing that the display apparatus 4 is a PC of notebook type having the Windows OS of the Microsoft Corporation mounted thereon.

The display apparatus 4 includes an image controller 100 which is a feature of the present embodiment, as its component. The image controller 100 can cause a screen 1000 to display drawing data generated internally using a drawing function mounted on the PC. The image controller 100 can receive objects from object transmission apparatuses 2B, 2C, 2D and 2E by utilizing a function of an object receiver 20.

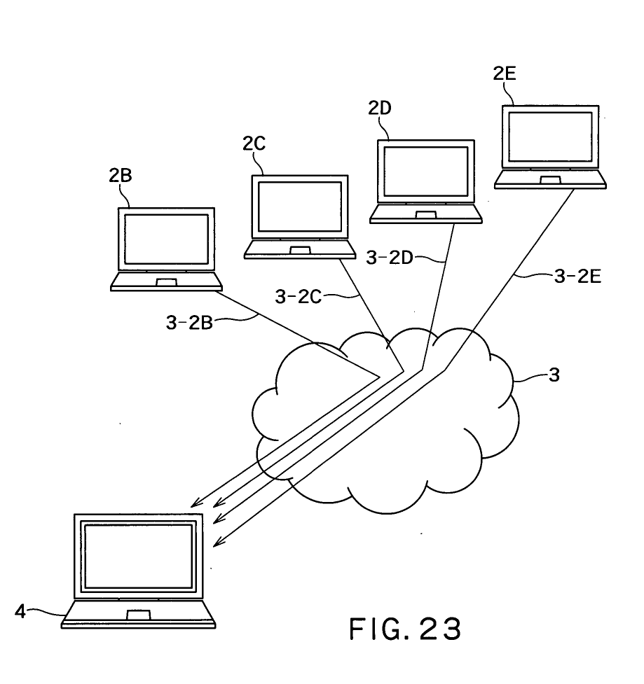

Hereafter, the present embodiment will be described supposing that the objects are video data. Furthermore, it is supposed that the display apparatus 4 is connected to the object transmission apparatuses 2B, 2C, 2D and 2E via a network 3 as shown in FIG. 23.

The image controller 100 includes an image signal generator 200, a receiver 300, a window overlap detector 400, a layout determiner 500, a layout control signal generator 600, a transmitter 700 and a composition layout controller 800′.

Upon being supplied with video data from an object receiver 20, the composition layout controller 800′ generates a composite video image from them, and outputs video data concerning the generated video image to the receiver 300. Upon being supplied with the video data from the composition layout controller 800′, the receiver 300 outputs the video data to the image signal generator 200. The receiver 300 may operate to periodically acquire video data from the composition layout controller 800′.

The image signal generator 200 has a function of generating and displaying a window 1001. The image signal generator 200 constructs video data which can be displayed, from video data input from the receiver 300, and displays the video data, for example, in the display area 1011 in the window 1001 as shown in FIG. 2 as “a video image.”

The window overlap detector 400 can detect a display position, a size and a transparency, of a different window 1002 which differs from the window 1001 displayed on the screen 1000. By utilizing the function, the window overlap detector 400 can detect whether a different opaque window overlaps the display area 1011 in the window 1001 and detect its overlapping quantity.

The layout determiner 500 is the same in operation as the layout determiner 500 described in the first embodiment. The layout determiner 500 manages layout information as shown in FIG. 6 therein.

The layout control signal generator 600 is the same in operation as the layout control signal generator 600 described in the first embodiment.

Upon being supplied with the layout control signal from the layout control signal generator 600, the transmitter 700 outputs the layout control signal to the composition layout controller 800′.

The composition layout controller 800′ has two functions: the function of the object composer 900 and the function of the composition layout controller 800 in the conference server 2 described in the first embodiment.

Upon being supplied with four video data 20B, 20C, 20D and 20E from the object receiver 20, the composition layout controller 800′ composes them and generates a composite video image 60A. In generating a composite video image 60A, the composition layout controller 800′ has a function of being able to adjust the image size, arrangement position and layer position of the respective video data. The composition layout controller 800′ manages the composite video image 60A by using X-Y coordinates with each of the horizontal direction and the vertical direction normalized to a value of 100 as shown in FIG. 17, and manages the image size, arrangement position and layer position of each video data by using a layout management table as shown in FIG. 18. ID numbers in the layout management table identify four video data 20B, 20C, 20D and 20E. An arrangement position (x, y), a size (w, h) and a layer of each video data are described in the layer management table. The composition layout controller 800′ determines arrangement positions of respective video data in the composite video image 60A by using the layout management table, and generates the composite video image 60A. At that time, however, it is possible to upscale, downscale or cut video images as occasion demands, or conduct surrounding completion or layer control.

Upon being supplied with the layout control signal from the transmitter 700, the composition layout controller 800′ analyzes the layout control signal, and then updates the contents of the layout management table on the basis of a result of the analysis. In addition, the composition layout controller 800′ changes arrangement positions of respective video data in the composite video image 60A by utilizing the result.

As described earlier, “the layout control signal generator 600 is the same in operation as the layout control signal generator 600 described in the first embodiment.” Instead of generating the layout control signal and outputting the layout control signal to the composition layout controller 800′ via the transmitter 700 as described with reference to the first embodiment and as shown in FIG. 7, however, the layout control signal generator 600 may send only an event notice to the effect that the layout has been changed to the composition layout controller 800′ in the present embodiment. Upon receiving the event notice in this case, the composition layout controller 800′ refers to the layout information managed by the layout determiner 500. At this time, the layout control signal generator 600 or the transmitter 700 may intercede with the processing. In addition, in this case, the composition layout controller 800′ may not have the layout management table therein, but may utilize the layout information managed by the layout determiner 500 as it is, as the layout management table.

FIG. 19 shows how the composite video image 60A is generated from the video data 20B, 20C, 20D and 20E for the layout management table shown in FIG. 18, as an example of processing conducted in the composition layout controller 800′. This processing is conducted as described in the first embodiment.

It is now supposed that a different window 1002 shown in FIG. 5 is moved onto a window 1001 in which a composite video image is displayed, by user's operation. In this case, processing similar to that described in the first embodiment is executed.

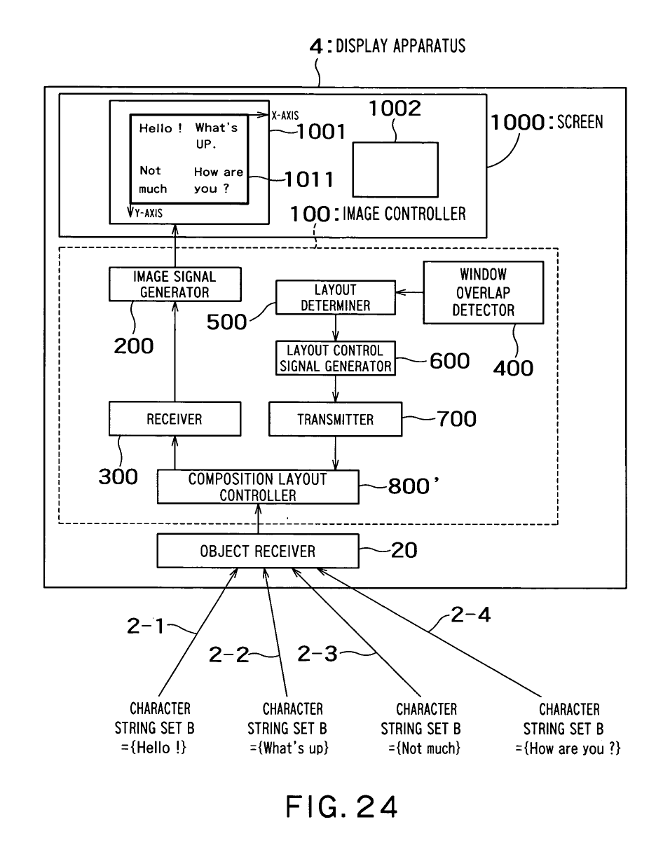

The present embodiment has been described supposing that the objects are the video data. However, the present embodiment is not restricted to it. For example, the case where data transmitted from each object transmission apparatus is a set of character strings will now be described. Sets of character strings transmitted by the object transmission apparatuses 2B, 2C, 2D and 2E are supposed to be a set B, a set C, a set D and a set E, respectively. Components in the image controller 100 are components which execute processing with the video data or the display area of it described above replaced by a set of character strings or a display area of it. For example, upon being supplied with four sets of character strings: the set B, the set C, the set D and the set E from the object receiver 20, the composition layout controller 800′ composes those sets and generates a composite character string set. At this time, the layout management table manages display positions and sizes of respective character string sets. FIG. 24 shows how a composite character string is generated from character string sets and the composite character string is displayed. In FIG. 24, the layout information shown in FIG. 6 is supposed. FIG. 24 shows how respective character strings are displayed in positions specified by the layout information.

According to the description of the present embodiment, the display apparatus 4 is connected to the object transmission apparatuses 2B, 2C, 2D and 2E via the network 3 as shown in FIG. 23. Alternatively, the object transmission apparatuses 2B, 2C, 2D and 2E may not be devices different from the display apparatus 4, but may be modules which are present in the display apparatus 4. In that case, for example, the object receiver 20 and the object transmission apparatuses are connected by an internal bus (such as a PCI bus) in the display apparatus 4.

Functions represented by the configurations shown in FIGS. 22 and 24 may be implemented by causing a computer to execute a program generated using an ordinary programming technique, or may be implemented using hardware.

Heretofore, the detailed configuration and operation of the display apparatus 4 have been described as the second embodiment. The second embodiment can be said to be a special example in the case where the video composition function disposed in the conference server in the first embodiment is locally provided. In the case where a different front window overlaps a window which displays a composite object, it becomes possible to dynamically rearrange the composite object so as to display the composite object in an area having no overlapping while following the movement of the front window in the same way as the first embodiment.

For example, when a certain PC in a surveillance camera system receives video images at a plurality of points, composes the video images, and displays a composite video image in one window, starting a different work window causes an important video image to be unseen in some cases. According to the present embodiment, however, the composite layout is changed following the movement of the front overlapping window and each surveillance video image is displayed in an area having no overlapping.

The video sources are not restricted to those received via the network, but they may be video data retained internally. Even if the video sources are, for example, character strings, the composite layout is changed following the movement of the front overlapping window and the subjects to be composed are displayed in non-overlapped areas.

### Third Embodiment

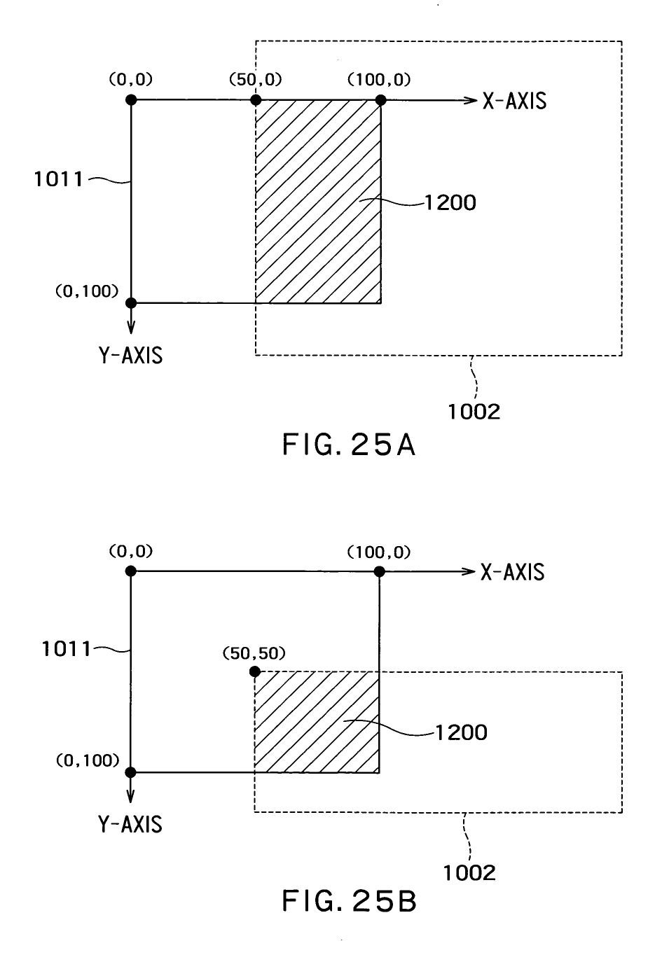

Hereafter, a third embodiment of the present invention will be described with reference to FIGS. 25A to 32B.

The present embodiment shows concrete examples of the method in which the window overlap detector 400 described in the first embodiment and the second embodiment detects overlapping of a different window, and the method in which the layout determiner 500 calculates and determines the layout information so as to avoid the overlapping area on the basis of the overlapping quantity.

The window overlap detector 400 has a function of detecting that a different opaque window 1002 overlaps its own window 1001. For example, if the Windows OS of the Microsoft Corporation is mounted as the OS, a technique for detecting that a different front opaque window overlaps a certain window by utilizing the function of Win32 API provided by the system is self-evident. It becomes possible to recognize the position and size of the different window 1002 by, for example, acquiring information including four pieces of information: top left coordinates and bottom right coordinates called RECT structure, from the system by utilizing the handle information. The window overlap detector 400 determines whether the overlapping of the different window 1002 is present in the display area 1011 in its own window 1001. If there is overlapping in the display area 1011, the window overlap detector 400 detects overlapping. The window overlap detector 400 judges a different window which overlaps the own window 1001, but which does not overlap the display area 1011 not to overlap.

Upon detecting overlapping caused by the different window, the window overlap detector 400 can represent the overlapping quantity by analyzing the information of the RECT structure of the different window and utilizing X-Y coordinates indicating the display area 1011. For example, if the different window 1002 overlaps an area represented by X>50 in the display area 1011 as shown in FIG. 25A, its overlapping quantity 1200 is represented as “overlapping position: X>50.” If the different window 1002 overlaps an area represented by X>50 and Y>50 in the display area 1011 as shown in FIG. 25B, its overlapping quantity 1200 is represented as “overlapping position: X>50 and Y>50.”

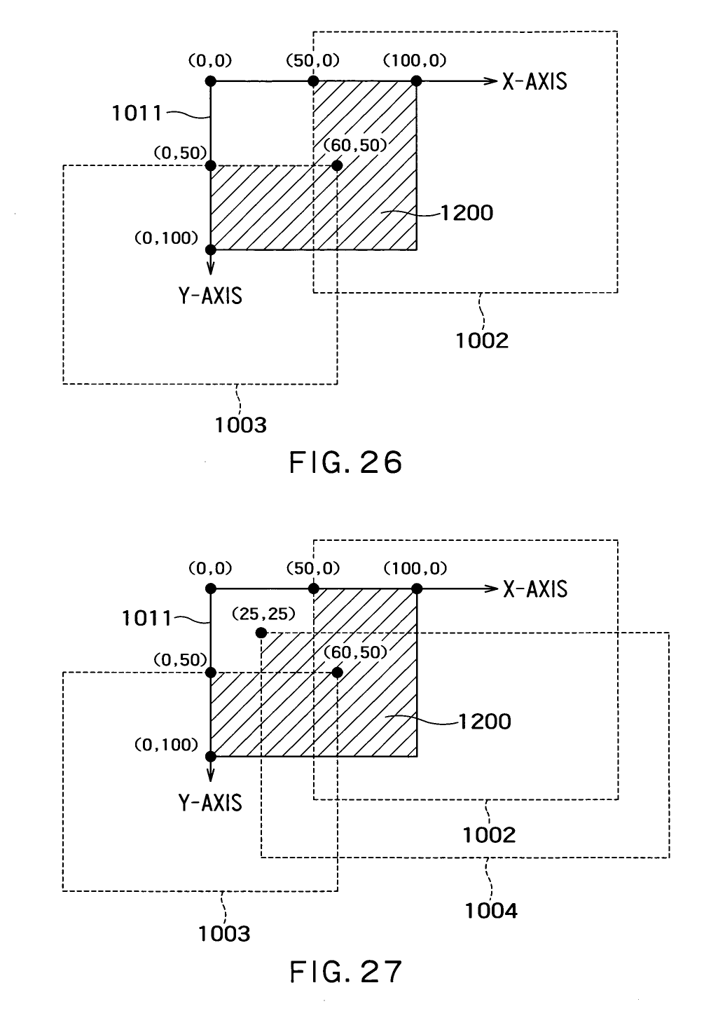

The number of the overlapping window is not restricted to one. The window overlap detector 400 judges sometimes a plurality of different windows to overlap. For example, it is supposed that two different windows 1002 and 1003 overlap the display area 1011 as shown in FIG. 26. In this case, the overlapping quantity caused by the different window 1002 is “overlapping position: X>50” and the overlapping quantity caused by the different window 1003 is “overlapping position: X<60 and Y>50.” Therefore, the total overlapping quantity of them becomes “overlapping position: (X>50) or (X<60 and Y>50).” In the case of FIG. 27, a different window 1004 also overlaps besides the overlapping shown in FIG. 26. In this case, the total overlapping quantity becomes “overlapping position: (X>50) or (X<60 and Y>50) or (X>25 and Y>25).”

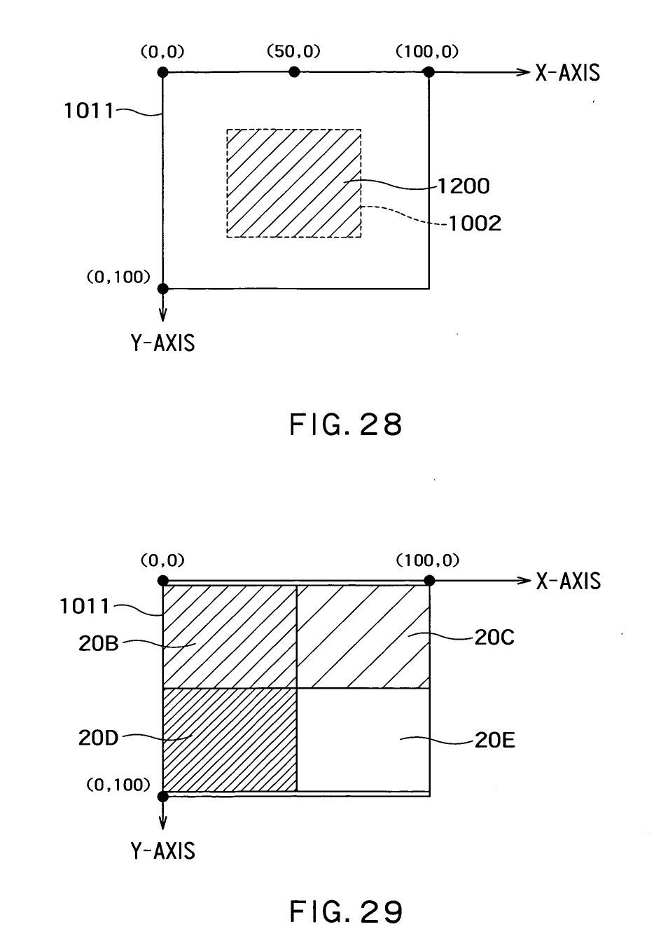

In some cases, the different window 1002 overlaps as shown in FIG. 28. In this case, the overlapping quantity becomes “overlapping position: X>20 and X<75 and Y>25 and Y<75.”

On the other hand, upon being supplied with information concerning the above-described overlapping quantity from the window overlap detector 400, the layout determiner 500 conducts calculation to find non-overlapping areas and determines layout arrangement. Hereafter, processing of arranging respective video images (20B, 20C, 20D and 20E) included in the composite video image in non-overlapping areas conducted by the layout determiner 500 will be described.

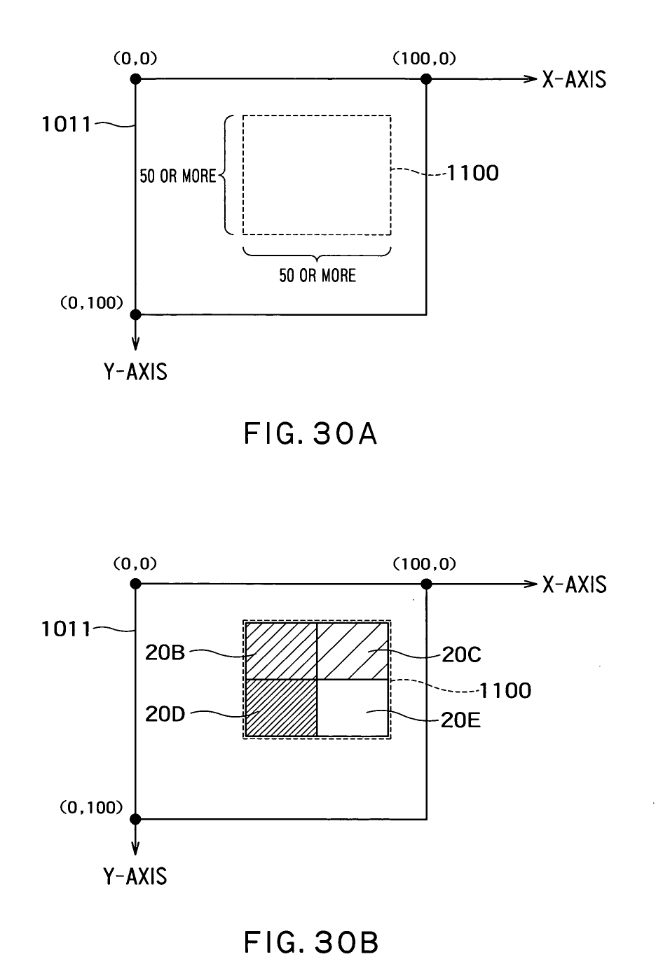

For example, FIG. 29 shows a composite video image including four video sources 20B, 20C, 20D and 20E. If, as shown in FIG. 30A, the layout determiner 500 can detect a sizable non-overlapping area 1100 having 50 or more in the horizontal direction and 50 or more in the vertical direction as a non-overlapping area in the display area 1011 represented by 100 and 100 in X-Y coordinates, then the layout determiner 500 determines layout information so as to downscale the whole while maintaining the positions of arrangement relations of the video sources 20B, 20C, 20D and 20E shown in FIG. 29. FIG. 30B shows the case where the composite video image of the video sources is downscaled to a size which is 50 in the vertical direction and 50 in the horizontal direction while maintaining the arrangement relation shown in FIG. 29.

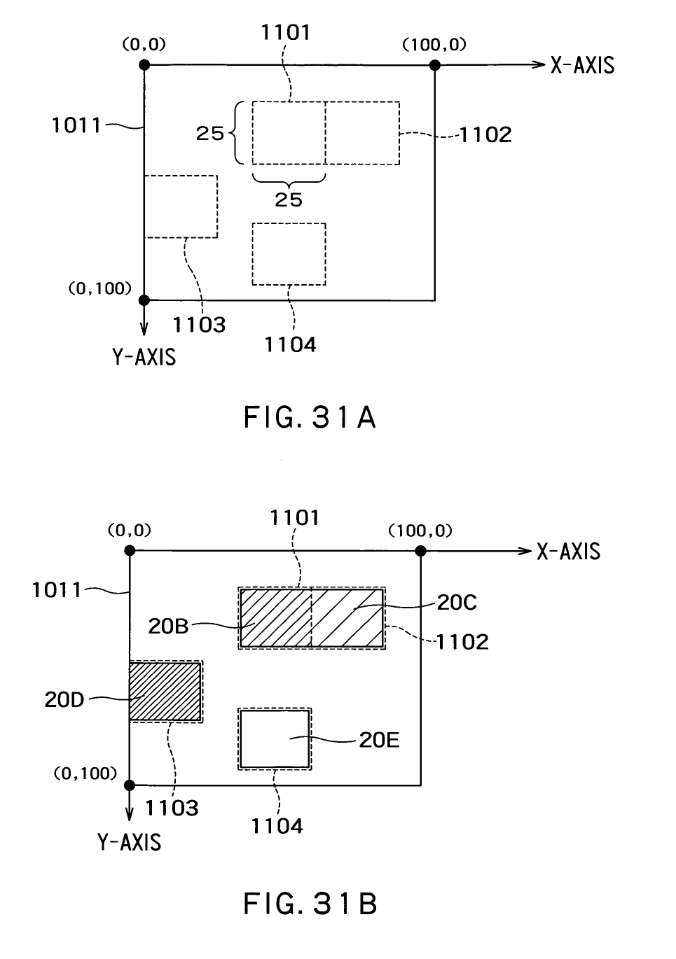

On the other hand, if a sizable area having 50 or more in the horizontal direction and 50 or more in the vertical direction cannot be detected, it is determined whether four areas having 25 in the horizontal direction and 25 in the vertical direction can be detected as the non-overlapping areas. If, as shown in FIG. 31A, four non-overlapping areas (1101, 1102, 1103 and 1104) each having 25 in the horizontal direction and 25 in the vertical direction can be detected, the layout determiner 500 determines the layout information so as to arrange the video sources 20B, 20C, 20D and 20E in those four areas. FIG. 31B shows the case where the video sources are downscaled and arranged in the four areas each having 25 in the vertical direction and 25 in the horizontal direction. For example, beginning with the top left (x=0, y=0) in X-Y coordinates, y=0 is fixed and retrieval of areas is conducted successively in the rightward direction. If areas each having 25 in the vertical direction and 25 in the horizontal direction can be secured, then they are secured and the video sources 20B, 20C, 20D and 20E are successively assigned to those areas. If only three or less areas can be secured as a result of the retrieval conducted with y fixed to y=0, the value of y is increased to (for example, y=25) and retrieval in the rightward direction is conducted in the same way. On the other hand, if any area cannot be secured as a result of the retrieval conducted with y fixed to y=0, then the value of y is increased (to, for example, y=1) and area retrieval is conducted in the rightward direction in the same way.

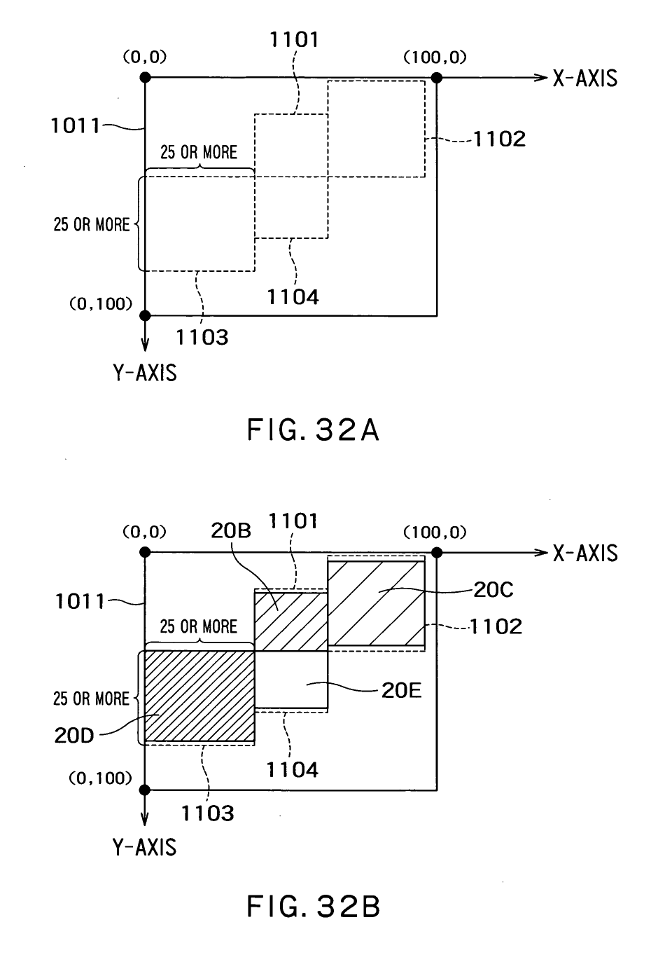

Although the algorithm for area detection becomes complicated as compared with the case where four areas each having a fixed size which is 25 in the horizontal direction and 25 in the vertical direction are detected, if a sizable area having 50 or more in the horizontal direction and 50 or more in the vertical direction cannot be detected, a method of detecting four areas each having 25 or more in the horizontal direction and 25 or more in the vertical direction as non-overlapping areas can also be used. FIGS. 32A and 32B show the case where four areas each having 25 or more in the horizontal direction and 25 or more in the vertical direction are detected and video sources are downscaled and arranged in those four areas.

If the sizable non-overlapping area having 50 or more in the horizontal direction and 50 or more in the vertical direction cannot be detected or four non-overlapping areas each having 25 in the horizontal direction and 25 in the vertical direction cannot be detected, then immediately preceding layout information may be retained without changing the layout. By doing so, unnecessary screen changes and layout changes can be suppressed.

Alternatively, the layout change may not be conducted when the overlapping quantity detected by the window overlap detector 400 is small or, for example, when the overlapping quantity is 10% or less for the area of the display area 1011. For example, when the composite video image is displayed in the display area 1011 as shown in FIG. 29, if the overlapping of the different window 1002 is approximately 5%, the layout determiner 500 does not conduct the layout change processing. By doing so, screen changes and layout changes the user might feel subjectively unnecessary can be suppressed.

In the present embodiment, an example of an algorithm used to determine the layout information on the basis of the overlapping quantity has been shown. However, an algorithm to be used is not restricted to this algorithm, but other algorithms may also be used.

Heretofore, a concrete example of an algorithm which changes the composite layout while following the movement of the front overlapping window to display objects to be composed in non-overlapping areas, has been described as the third embodiment of the present invention. In addition to the effects described in the first and second embodiments, it also becomes possible to suppress screen changes and layout changes the user might feel subjectively unnecessary by using the technique described in the third embodiment of the present invention.

### Fourth Embodiment

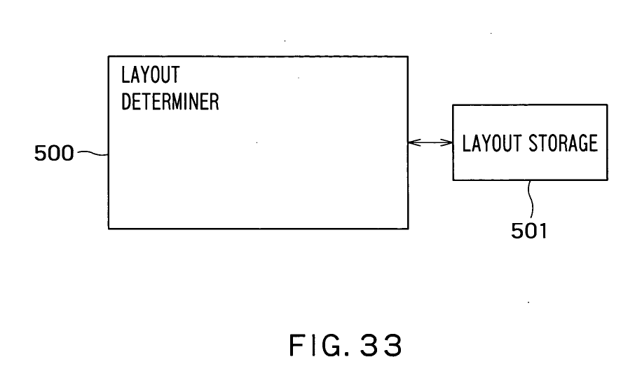

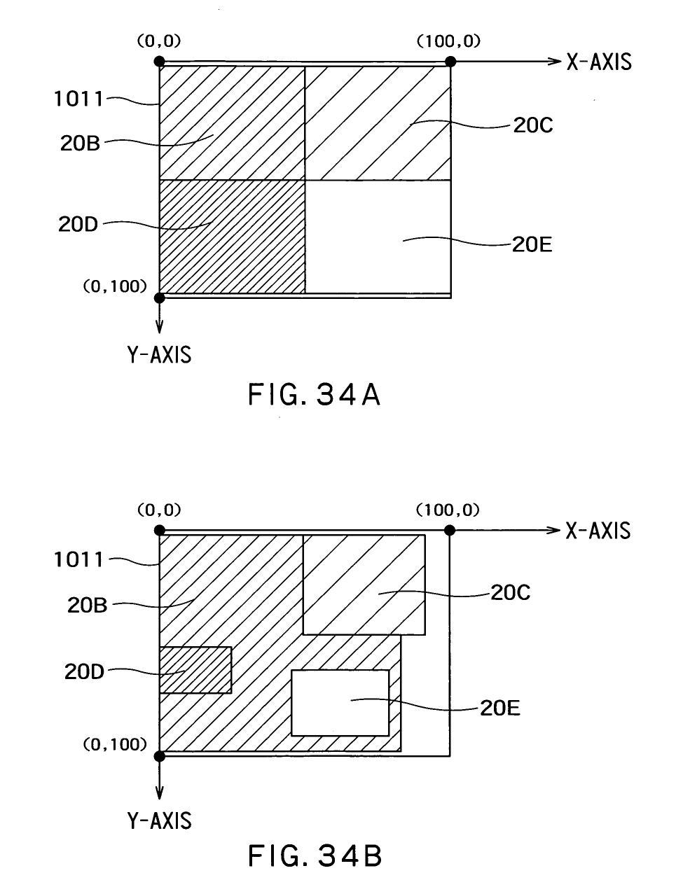

Hereafter, a fourth embodiment of the present invention will be described with reference to FIG. 33 and FIGS. 34A and 34B.

In the present embodiment, there will be described operation conducted when an layout storage 501 shown in FIG. 33 is added to the layout determiner 500 included in the image controller 100 of the conference terminal 1 described in the first embodiment or included in the image controller 100 of the display apparatus 4 described in the second embodiment.

The layout determiner 500 can store layout information to be used when the window overlap detector 400 does not detect overlapping of a different window, in the layout storage 501.

In the third embodiment, only the case where four video sources 20B, 20C, 20D and 20E are composed according to respective layouts shown in FIG. 34A in the default state has been considered. In the present embodiment, however, the layouts can be changed freely by user's operation as shown in FIG. 34B in the state in which there is no overlapping of a different window.

For example, in the third embodiment, the method of automatically changing the layout of the each video source when overlapping of the different window has been detected has been described. In the present embodiment, however, by providing the layout storage 501, it becomes possible to restore the screen layout set freely by the user beforehand (second user layout) on the basis of layout information stored in the layout storage 501 when overlapping of a different window has disappeared.

Furthermore, it is also possible to store two or more pieces of layout information in the layout storage 501. For example, one of the pieces of the layout information is layout information set freely by the user in the non-overlapping state, and the other is favorite layout information specified (selected) by the user. In this case, for example, it is possible to not only change the layout in accordance with the algorithm shown in the third embodiment when overlapping is detected, but also change the layout to the favorite layout specified by the user (first user layout) when overlapping of a certain definite quantity is detected.

Heretofore, the case where the layout information is stored has been described as the fourth embodiment of the present invention. According to the present invention, in the case where the user can freely change the composite layout in the state in which there is not overlapping of a different window, it also becomes possible to positively restore the layout in the non-overlapping state when overlapping has disappeared.

What is claimed is:

1. A display apparatus which displays a first window and a second window, comprising:
a receiver configured to receive a composite object obtained by composing a first object and a second object, from a server;
a display unit configured to display the composite object in the first window;
a window overlap detector configured to detect an overlap between the second window and the composite object in the first window, and to obtain a position of the overlap in the first window;
a layout determiner configured to determine layouts of the objects in the composite object according to the position of the overlap so as not to place the first object and the second object on the position of the overlap; and
a transmitter configured to transmit information of the layouts of the objects determined by the layout determiner, to the server.

2. The display apparatus according to claim 1, further comprising
a storage configured to store layout information including identifiers identifying the objects in the composite object and positions of the objects in the first window, wherein
the layout determiner discriminates each object in the composite object according to the layout information, and updates the storage by using the determined layouts of the objects.

3. The display apparatus according to claim 1, wherein the layout determiner selects a size for each of the objects from among a plurality of predetermined sizes.

4. The display apparatus according to claim 1, further comprising
a first user layout storage configured to store one or more first user layouts each of which represents layouts specified by a user beforehand for the objects,
wherein
the layout determiner selects the first user layout from the first user layout storage, and
the layout transmitter transmits information of the selected first user layout to the server.

5. The display apparatus according to claim 1,
further comprising a second user layout storage configured to store a second user layout which represents layouts specified by a user beforehand for the objects,
wherein
when the overlap is disappeared, the transmitter transmits information of the second user layout to the server.

6. The display apparatus according to claim 1, further comprising
a storage configured to store a threshold, wherein
the window overlap detector determines that the overlap exists when an area size of the overlap exceeds the threshold.

7. A display apparatus which displays a first window and a second window, comprising:
an object receiver configured to receive a first object and a second object;
a layout storage configured to store layouts of the first object and the second object;
a composite object generator configured to compose the first and second objects according to the layouts of the first and second objects to generate a composite object;
a display unit configured to display the composite object in the first window;
a window overlap detector configured to detect overlap between the second window and the composite object in the first window, and to obtain a position of the overlap in the first window;
a layout determiner configured to determine layouts of the first and second objects according to the position of the overlap so as not to place the first object and the second object on the position of the overlap; and
a layout updater configured to update the layouts of the first and second objects in the layout storage by using the determined layouts of the first and second objects.

8. The display apparatus according to claim 7, wherein the layout determiner selects a size of each of the objects from among a plurality of predetermined sizes.

9. The display apparatus according to claim 8, wherein the composite object generator downscales or upscales the object to the selected size.

10. The display apparatus according to claim 9, wherein if the composite object generator is not adaptable to the downscaling to the selected size, the composite object generator extracts a part of the object.

11. The display apparatus according to claim 9, wherein if the composite object generator is not adaptable to the downscaling or upscaling to the selected size, the composite object generator downscales or upscales the object to a adaptable size, and complements surrounding of the downscaled or upscaled object up to the selected size.

12. The display apparatus according to claim 7, further comprising
a first user layout storage configured to store one or more first user layouts each of which represents layouts specified by a user beforehand for the objects,
wherein
the layout determiner selects the first user layout from the first user layout storage, and
the layout updater updates the layouts of the objects in the layout storage according to the selected first user layout.

13. The display apparatus according to claim 7, further comprising
a second user layout storage configured to store a second user layout which represents layouts specified by a user beforehand for the objects,
wherein
when the overlap is disappeared, the layout updater updates the layouts of the objects in the layout storage according to the second user layout.

14. The display apparatus according to claim 7, further comprising
a storage configured to store a threshold, wherein
the window overlap detector determines that the overlap exists when a size of the overlap exceeds the threshold.

15. A program which is executed by a computer, comprising instructions for:
receiving a composite object obtained by composing a first object and a second object, from a server;
displaying the composite object in a first window;
detecting overlap between a second window and the composite object in the first window;
obtaining a position of the overlap in the first window;
determining layouts of the objects in the composite object according to the position of the overlap so as not to place the first object and the second object on the position of the overlap; and
transmitting information of the determined layouts to the server.

16. A program which is executed by computer, comprising instructions for:
receiving a first object and a second object;
composing the first and second objects according to layouts of the first and second objects to generate a composite object;
displaying the composite object in a first window;
detecting overlap between a second window and the composite object in the first window;
obtaining a position of the overlap in the first window;
determining layouts of the objects on the basis of the detected position so as not to place the first object and the second object on the position of the overlap; and
updating the layouts of the first and second objects by using the determined layouts of the first and second objects.
